(19) United States
(12) Patent Application Publication
(10) Pub. No.: US 2019/0101313 A1
(43) Pub. Date: Apr. 4, 2019

(54) VEHICULAR AIR CONDITIONING SYSTEMS

(71) Applicant: Sigma Air Conditioning Pty Ltd, Granville (AU)

(72) Inventors: Rodney Clark, Labrador (AU); Joshua Pitcher, Epping (AU); Anthony Fry, Woy Woy (AU)

(21) Appl. No.: 15/777,350

(22) PCT Filed: Aug. 8, 2016
(86) PCT No.: PCT/AU2016/050717

§ 371 Date: May 18, 2018

(30) Foreign Application Priority Data
Nov. 19, 2015 (AU) 2015904767

(51) Int. Cl. F25B 49/02; B60H 1/00; B60H 1/32

(52) U.S. Cl. CPC F25B 49/022; F25B 2700/21175; B60H 1/0045; B60H 1/3222; B60H 1/323; B60H 2001/3272; B60H 2001/3282; F25B 2327/001; F25B 2400/0401; F25B 2400/075; F25B 2600/0253; F25B 2600/111; F25B 2600/2501; F25B 2700/1931; F25B 2700/1933; F25B 2700/195; F25B 2700/197; F25B 2700/2104; F25B 2700/2106; F25B 2700/21163; B60H 1/00428

(57) ABSTRACT

A vehicular air conditioning system is described including: an electrically powered compressor; the electrically powered compressor is controllable to operate at a range of speeds; and a condenser fan which is controllable to operate at a range of speeds.

### TECHNICAL FIELD

The present invention relates to vehicular air conditioning systems.

### BACKGROUND TO THE INVENTION

Vehicles are provided with HVAC (Heating Ventilation and Air-Conditioning) systems to maintain an atmosphere in the vehicle cabin which is ventilated and maintained at a temperature that is comfortable for vehicle occupants. Such systems are typically only operational when the vehicle engine is running. This is largely due to the relatively high power requirements of the air-conditioning compressor of such systems. The compressor of a vehicular HVAC system is typically coupled to the engine of the vehicle by way of a V-belt or other drive coupling and therefore relies on the operation of the vehicle engine to operate.

It has been tried to modify vehicular HVAC systems to allow for operation of the air conditioning system when the vehicle engine is not running by utilising an electrically operated compressor which is powered by a storage battery. However, such systems have been found to be inefficient and/or unreliable.

There remains a need for improved vehicular HVAC systems which can operate without engine power.

### SUMMARY OF THE INVENTION

In a first aspect the present invention provides a vehicular air conditioning system including: an electrically powered compressor; the electrically powered compressor is controllable to operate at a range of speeds; and a condenser fan which is controllable to operate at a range of speeds.

Optionally, the system further includes a control device which is arranged to control the speed of the compressor or the condenser fan.

Optionally, the control device exerts control based on a comparison of cabin air temperature with external air temperature.

Optionally, the control device exerts control based on the remaining capacity of an electric power source which powers the electrically powered compressor.

In a second aspect the present invention provides a vehicular air conditioning system including a refrigerant circuit including: an electrically powered compressor; an engine powered compressor; a condenser coil; an evaporator coil; both of the compressors are coupled with oil separators.

Optionally, check valves are installed in the circuit between the condenser coil and each compressor.

### BRIEF DESCRIPTION OF THE DRAWINGS

An embodiment of the present invention will now be described, by way of example only, with reference to the accompanying drawings, in which:

FIG. 1 is a schematic diagram showing components of a vehicular HVAC system operating in a first mode using engine power; and

FIG. 2 shows the vehicular HVAC system of FIG. 1 operating in a second mode running without vehicle engine power.

### DETAILED DESCRIPTION OF THE PREFERRED EMBODIMENT

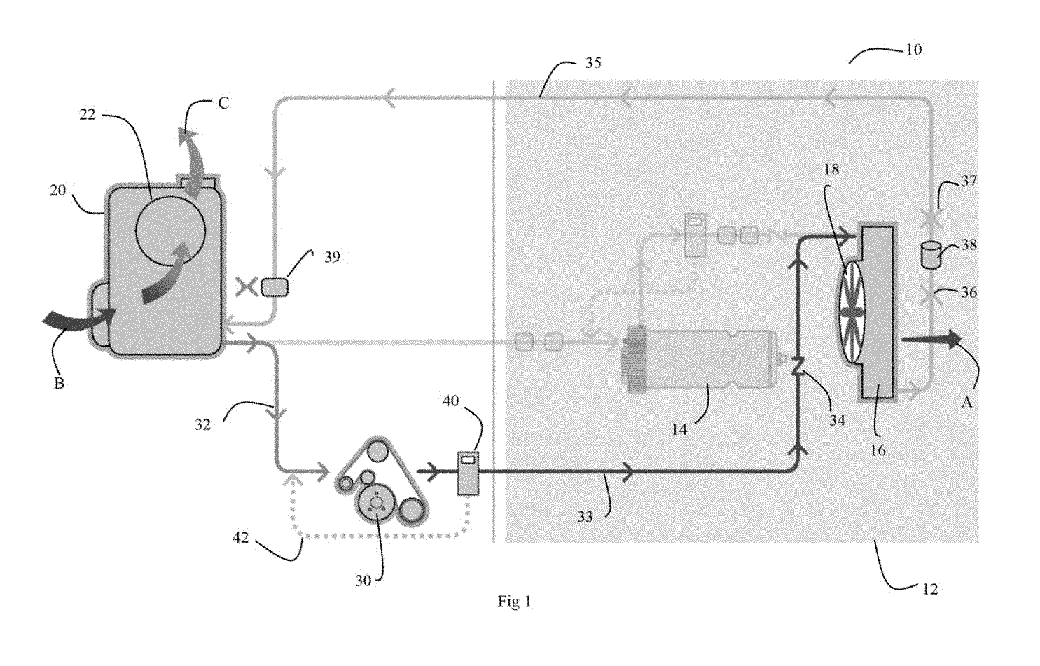

Referring to FIG. 1, the air conditioning system of a vehicular HVAC system 10 is shown including an electrically powered modulating DC compressor 14 which is controllable to operate at a number of speeds. The compressor speed is varied by a control signal. This control signal is typically in the form of an analogue input (e.g. 0-10 VDC or pulse-width-modulation PWM) where the speed of the compressor is proportional to the analogue level of this control signal.

Compressor 14 is part of a refrigerant circuit which includes a condenser coil 16 which is fitted with a variable speed fan 18, an evaporator 20 which is fitted with a variable speed evaporator fan 22 and an engine driven compressor 30.

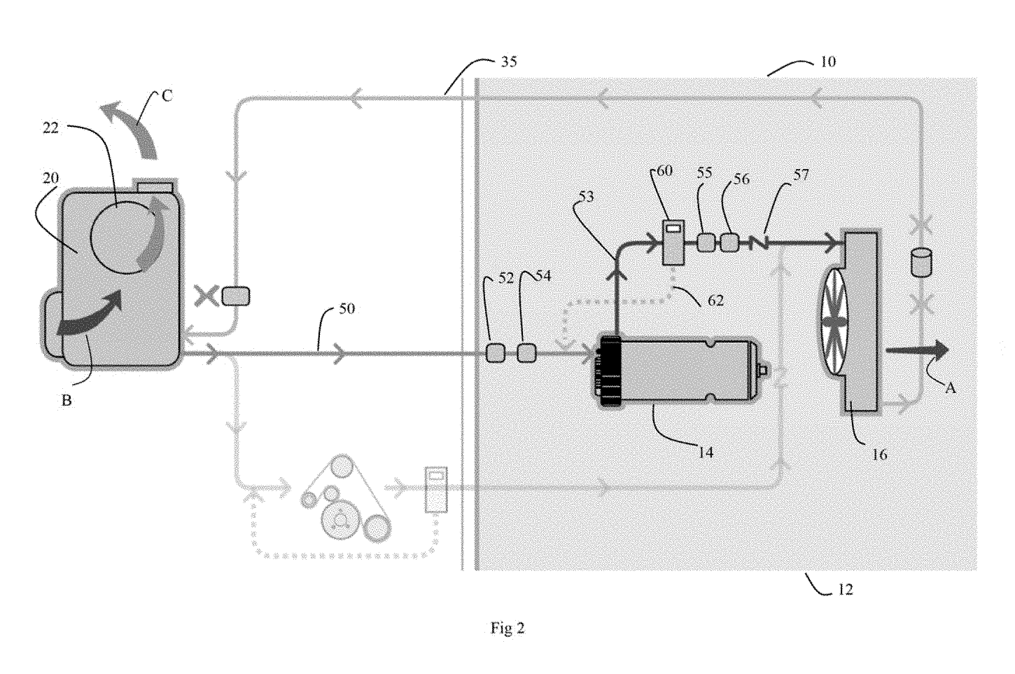

The HVAC system 10 is able to operate in two major modes. In FIG. 1, it is shown in the mode whereby refrigerant is being pumped by engine driven compressor 30. In FIG. 2, it is shown in the second mode wherein refrigerant is being pumped by electrically powered compressor 14.

Referring again to FIG. 1, in the first mode a suction line 32 delivers refrigerant to compressor 30 wherein it is compressed and pumped to condenser coil 16 by way of discharge line 33. A check valve 34 is provided in discharge line 33. Oil separator 40 separates lubricating oil from the refrigerant and returns it to compressor 30 by way of oil return line 42.

Refrigerant is condensed in the condenser coil 16 wherein it loses heat energy by way of warmed airflow indicated by arrow A. Refrigerant is then directed to evaporator coil 20 by way of liquid line 35. A sight glass 38 is provided in liquid line 35 by which the level or presence of refrigerant in the circuit can be visually inspected in a known manner. The sight glass is able to be isolated and replaced by closing service valves 36, 37.

Refrigerant is delivered through TX valve 39 to evaporator coil 20 wherein it expands to absorb heat from the air which is being blown through the evaporator coil 20 by evaporator fan 22. Air in vehicle cabin is drawn in by fan 22 indicated by arrow B. The air loses heat to evaporator coil 20 and emanates as cooled air indicated by arrow C. This cooled air is directed out of vents inside the vehicle.

Referring now to FIG. 2, in the second mode suction line 50 delivers refrigerant through low pressure switch 52 and low pressure sensor 54 to compressor 14 wherein it is compressed and pumped through high pressure switch 55 and high pressure sensor 56 to condenser coil 16 by way of discharge line 53. A check valve 57 is provided in discharge line 53. Oil separator 60 separates lubricating oil from the refrigerant and returns it to compressor 14 by way of oil return line 62.

As in the first mode, refrigerant is condensed in the condenser coil 16 wherein it loses heat energy by way of warmed airflow indicated by arrow A. Refrigerant is then directed to evaporator coil 20 by way of liquid line 35 and evaporates in evaporator coil 20 in the usual manner to provide cooled air inside the vehicle cabin.

System 10 is formed by modifying an existing vehicle by removing or disconnecting the existing vehicle condenser coil and installing a module which includes the components in grey area 12 in the figure. The compressor 14 is powered by a storage battery which may be the existing vehicle battery, or may be a dedicated additional battery which is installed in the vehicle. In some embodiments, the compressor is powered by a dedicated small sized electrical generator.

System 10 incorporates the following significant features:

### 1. High Efficiency Control

System 10 operates under the control of a logic control device incorporated into module 12. The control device takes in a number of machine and environmental inputs to determine when to activate the HVAC and set the operating parameters to maximise efficiency and therefore minimise power consumption as follows:

### Machine Inputs:

1. Engine running status
2. Driver presence indication
3. Manual override/activation/de-activation

### Environmental Inputs

1. Cabin temperature
2. Outside temperature

### HVAC Inputs

### 1. Condenser Temperature

### 2. Condenser Pressure

### 3. Compressor Suction Pressure

### 4. Compressor Discharge Pressure

### 5. Evaporator Pressure

### 6. Evaporator Temperature

7. Evaporator Superheat temperature
8. Condenser Cub-cooling temperature

Not all control inputs may be used in any particular installation.

The supply fan 22, condenser fan 18 and compressor 14 all have variable speed control to enable the system to be maintained at the most efficient control point. This extends the life of the available power source (in this case battery) in two ways. Firstly, the power consumption is minimised through maximising efficiency. Secondly operation at lower current draw from a lead-acid battery results in higher available capacity due to Peukert's Law. For non-battery power sources, it also enables the selection of a smaller, quieter generator-based power source.

### 2. Driver Detection

System 10 is capable of detecting the presence of an operator in the vehicle cabin through one of a variety of driver detection devices means such as a seat mounted pressure switch, a motion detector or a perimeter detection device at the entry to the vehicle cabin. When the system detects that the operator has left the cabin, it reduces the operating power consumption allowing some degradation in cabin temperatures. However the degradation is kept small and still more comfortable than the outdoor conditions. Thus when the operator re-enters the cabin, there is an initial feeling of comfort from leaving the outdoor environment and once the driver presence is detected by the system, the system re-enters the normal configuration to enable the desired conditions to be quickly restored.

### 3. Graceful Degradation and Capacity Mapping

The control system allows the power drawn from the power supply and therefore HVAC performance to match the capacity of the power source to allow operation in applications with limited power availability. This may involve reducing the operating performance of the system as the battery capacity approaches the limit of its remaining capacity to deliver a partial or degraded performance and lengthen the battery life in return for degraded conditions.

### 4. Compressor Reliability Improvement

The system 10 enables two refrigeration systems to share the same condenser and evaporator coil through the usage of oil separation and non-return valves (check valves) between the two compressors. The oil separators ensure that the oil in each compressor is not mixed with the other, or that the oil from one compressor does not migrate to the other, causing wear on the compressor with low oil. The non-return (or “check”) valves ensure no backpressure refrigerant is passed from one compressor discharge to the other due to backpressure, thereby holding all refrigerant in the active circuit and also eliminating possible compressor damage from refrigerant flood-back.

### 5. Integrated Data Logging

The system 10 enables the pressure, temperature and machine data managed by the control algorithms (e.g. idling time) to be written to on-board memory over a long duration. This logging allows mapping the performance of the system, machine idle and running times, maintenance planning and enabling condition monitoring for predictive maintenance purposes. This data helps to minimise downtime, monitor driver behaviour and enables operators to quantify the benefits of the system.

Systems according to the invention have particular application in mining machinery applications such as bulldozers or mine trucks. These types of vehicles often operate in regions with very hot climates. Furthermore, during a working day a mining vehicle may not be constantly actively working. For instance, a vehicle may be waiting in a queue or waiting for some other event (eg loading or unloading), or the driver of a vehicle may be on a planned break. At other times unforseen disruptions may require vehicles to remain stationary and wait. During these times, it is common practice to leave the engine of the vehicle running to maintain operation of the vehicle air conditioning system.

Any reference to prior art contained herein is not to be taken as an admission that the information is common general knowledge, unless otherwise indicated.

Finally, it is to be appreciated that various alterations or additions may be made to the parts previously described without departing from the spirit or ambit of the present invention.

1. A vehicular air conditioning system including:
an electrically powered compressor;
the electrically powered compressor is controllable to operate at a range of speeds;
a condenser fan which is controllable to operate at a range of speeds; and
a control device which is arranged to control the speed of the compressor and the condenser fan;
wherein the control device exerts control based on a comparison of cabin air temperature with external air temperature.

2. A vehicular air conditioning system including:
an electrically powered compressor;
the electrically powered compressor is controllable to operate at a range of speeds;
a condenser fan which is controllable to operate at a range of speeds; and
a control device which is arranged to control the speed of the compressor and the condenser fan;
wherein the control device exerts control based on the remaining capacity of an electric power source which powers the electrically powered compressor.

3. (canceled)

4. (canceled)

5. A vehicular air conditioning system including a refrigerant circuit including:
an electrically powered compressor;
an engine powered compressor;
a condenser coil;
an evaporator coil;
both of the compressors are coupled with oil separators.

6. A vehicular air conditioning system according to claim 5 wherein check valves are installed in the circuit between the condenser coil and each compressor.
